(19) United States
(12) Patent Application Publication
(10) Pub. No.: US 2016/0068020 A1
(43) Pub. Date: Mar. 10, 2016

(54) PNEUMATIC TIRE FOR VEHICLES AND USE OF A THREAD MADE OF A TEXTILE MATERIAL

(71) Applicant: Continental Reifen Deutschland GmbH, Hannover (DE)

(72) Inventors: Wolfgang Reese, Peine (DE); Carole Justine, Scharrel (DE)

(21) Appl. No.: 14/945,001

(22) Filed: Nov. 18, 2015

Related U.S. Application Data
(63) Continuation of application No. PCT/EP2014/057564, filed on Apr. 15, 2014.

(30) Foreign Application Priority Data
May 21, 2013 (DE) 10 2013 105 163.4

(51) Int. Cl. B60C 9/20; B29D 30/38; B60C 9/00

(52) U.S. Cl. CPC B60C 9/2003; B60C 9/0042; B29D 30/38; B60C 2009/2096; B60C 2009/2074; B60C 2009/2083; B60C 2009/0092; B60C 2009/0071

(57) ABSTRACT

Radial-type pneumatic tires for vehicles having a radial carcass, a profiled tire tread, a belt and a single-layer or multi-layer bandage covering the belt, which bandage has reinforcements extending in the circumferential direction of the tire and includes at least one thread made of a textile material, such as polyamide, polyester or rayon. The thread has a fineness of ≦700 dtex.

### CROSS REFERENCE TO RELATED APPLICATIONS

This application is a continuation application of international patent application PCT/EP2014/057564, filed Apr. 15, 2014, designating the United States and claiming priority from German application 10 2013 105 163.4, filed May 21, 2013, and the entire content of both applications is incorporated herein by reference.

### FIELD OF THE INVENTION

The disclosure relates to a pneumatic vehicle tire in a radial construction comprising a radial carcass, a profiled tread strip, a belt and a belt bandage covering the belt in one or more plies comprising strength members extending in the circumferential direction of the tire and including at least one yarn in a textile material. The disclosure further relates to the method of using a yarn in a textile material having a fineness ≦700 dtex.

### BACKGROUND OF THE INVENTION

The cords in the belt bandage of pneumatic vehicle tires for passenger cars typically consist of twisted yarns in, for example, nylon-6,6 at 940 dtex or 1400 dtex. The cords accordingly have a relatively large diameter, and so the bandage ply thickness in the tire is also relatively large, which, in the operation of the tire, ultimately causes a heat build-up which increases the rolling resistance of the tire. United States patent application publication 2013/0240105 discloses a pneumatic vehicle tire containing in the belt bandage, as strength member, a cord cabled together from two or more multifilament yarns which are made of nylon-10,10, while the individual multifilament yarns have a fineness of 250 dtex to 4000 dtex in each case. The nylon-10,10 is used instead of the nylon-6,6 typically used for yarns because of its high mechanical strength and resistance to chemicals. U.S. Pat. No. 7,188,654 discloses a pneumatic vehicle tire whose belt bandage contains hybrid cords made of a first yarn having a high modulus of elasticity of not less than 25 000 N/mm², in particular aramid, and a second yarn having a low modulus of elasticity of not more than 15 000 N/mm², in particular nylon in a fineness ≧940 dtex, which are cabled together. Tires having a belt bandage comprising strength members of this type are stated to have good high-speed durability and an improved level of abrasion performance. United States patent application publication 2013/0728262 discloses using, in the belt bandage of a pneumatic vehicle tire, a reinforcement cord which is likewise a hybrid cord which consists of at least one yarn in nylon-6,6 having a fineness of 600 dtex to 2400 dtex and of at least one yarn formed from cellulose fibers, the yarns being folded together. A pneumatic vehicle tire having this cord in the belt bandage is stated to be altogether improved in its performance while offering high comfort.

### SUMMARY OF THE INVENTION

The problem addressed by the present disclosure is that of using a simple measure to reduce the rolling resistance of and to ensure a good high-speed performance for a tire of the type mentioned at the beginning.

The stated problem is solved when the yarn has a fineness ≦700 dtex.

It has been have determined that yarns having such a low fineness are very highly suitable for forming the strength members in the belt bandage of pneumatic vehicle tires. Strength members of this type can be arranged at higher density than the prior art strength members, so the belt bandage will ensure very good high-speed durability. The ply thickness of belt bandage plies comprising such strength members is lower than that of bandage plies as per the prior art, reducing the weight of the tire and the heat build-up as the tire rolls. This serves to reduce the rolling resistance of the tire.

The effects mentioned, in particular a reduced heat build-up as the tire rolls and a reduced rolling resistance, are particularly efficiently obtainable with yarns having a fineness ≦500 dtex as or in one or more strength members in the belt bandage.

The strength members in the belt bandage may be twisted yarns or cords consisting of two or more twisted yarns in the same material, in which case the cords may have one of the customary constructions 1×1, 1×2 and 1×3. The strength members may further be tapes formed from a number of zero twist yarns.

Useful strength members in the belt bandage include cords of the construction 1×1 with a twist factor α of 10 to 80, preferably 30 to 50, and further cords of the constructions 1×2 or 1×3 with a twist factor α of 50 to 300, preferably 100 to 200, wherein

$$α = t / m \times \sqrt{\frac{dtex}{10000}} ,$$

where t/m is the number of twists per meter and dtex is the dtex of the entire cord.

To ensure good penetration of rubber between the cords and/or strength members, the strength members are spaced apart within and between bandage plies by a clear distance of not less than 0.1 mm.

In one preferred embodiment, the yarn comprises or consists of nylon-6,6. However, the yarn may also be made of a different textile material, for example polyester, rayon or highly aromatic polyamide.

The disclosure further provides the method of using a twisted yarn in a textile material having a fineness ≦700 dtex as strength member or in the manufacture of reinforcement cords for at least one bandage ply covering the belt of a pneumatic vehicle tire in radial construction.

The disclosure may preferably employ a commercially available yarn in nylon-6,6, in particular one having a fineness of 700 dtex, 470 dtex, 312 dtex or 235 dtex.

### DESCRIPTION OF THE PREFERRED EMBODIMENTS OF THE INVENTION

Further features, advantages and details of the invention will become apparent from the description hereinbelow.

Pneumatic vehicle tires are tires in radial construction that are envisaged for passenger cars in particular. These pneumatic vehicle tires typically include not only a radial carcass, anchored in bead regions by wrapping around bead cores strong in tension, but also a radially outside, profiled tread strip, further a belt located between the tread strip and the radial carcass and composed of at least one belt ply comprising rubberized strength members, and a belt bandage disposed between the tread strip and the belt. The belt bandage, which may have one or more plies, covers the belt and overcovers the lateral edges of the belt plies. Belt bandage plies are produced in particular as a wound bandage, formed by winding at least one strip of strength members embedded in an unvulcanized mixture of rubber, which extend in the longitudinal direction of the strip(s) and in the circumferential direction of the ready-produced tire, helically onto the belt. Winding may be effected such that the individual coils of the strip abut or partly overlap. Gap winding, where the coils are left a small distance apart, is a further possibility. The strength members in one embodiment are cords consisting of twisted yarns in that two or more, for example two or three, yarns are folded together to make up one cord. The strength members may be individual cords arranged a small distance apart and rubberized together to form a strip. The strength members may also be the warp threads of a woven fabric, which is calendered and subsequently cut into strips.

The strength members in yet a further embodiment may also be twisted yarns. Strength member separation in the rubber mixture strips is not less than 0.1 mm, preferably not less than 0.2 mm.

The twisted yarn is made from a textile material such as polyester, polyamide, rayon, or highly aromatic polyamide, in particular of nylon-6,6 with a fineness ≦700 dtex, preferably ≦500 dtex. Of the currently commercially available nylon-6,6 yarns, therefore, 700 dtex, 470 dtex, 312 dtex or 235 dtex yarns are contemplated for example. The strips of material which are produced using such yarns and/or cords comprising such yarns can be made significantly thinner than the strips of material for wound bandages as per the prior art, which for example contain cords formed from 940 dtex or 1400 dtex nylon-6,6 yarns. Because the density of the strength members and/or cords in the strips of material for the wound bandage and also in the belt bandage plies formed therefrom can be chosen to be significantly greater than in prior art strips of material and/or belt bandage plies, bandage plies according to the disclosure have a strength comparable to that of belt bandage plies in the prior art. Yet the thickness of the bandage plies according to the disclosure and therefore their weight are lower than for prior art bandage plies, which also serves to reduce the weight of the pneumatic vehicle tire. This results in a lower build-up of heat in the belt and/or tread strip region of the tire, particularly at relatively high speeds, thereby reducing the rolling resistance of the tire.

The yarn is employed either twisted as a cord in one of the constructions 1×1, 1×2 and 1×3, or untwisted as tape (formed from two or more yarns lying flat side by side). The clear distance between the individual strength members and/or cords in the bandage ply or plies in the tire should be not less than 0.1 mm, the same applying to the clear distance between the strength members and/or cords of bandage plies arranged on top of each other. This minimum distance ensures good penetration of rubber between the individual strength members and prevents the strength members coming into contact with each other.

A twist factor α may be defined for the cords, as follows:

$$α = t / m \times \sqrt{\frac{dtex}{10000}} ,$$

where t/m is the number of twists per meter, and
dtex is the dtex sum total of all the yarns in the cord, that is, the dtex of the entire cord.

The twist factor α for 1×1 constructions should be in the range from 10 to 80, preferably 30 to 50, while the twist factor α of 1×2 and 1×3 constructions should be in the range from 50 to 300, preferably from 100 to 200.

Yarns and/or strength members according to the disclosure can be used to make the belt bandage in the tire by processing from a calendered woven fabric cut into strips; from an extruded material cut into strips; or else as a rubberized individual cord. Another possibility is their use in the form of a tackily impregnated individual cord which, thus, is wound without rubberization directly onto the green tire and/or the belt package.

It is understood that the foregoing description is that of the preferred embodiments of the invention and that various changes and modifications may be made thereto without departing from the spirit and scope of the invention as defined in the appended claims.

What is claimed is:

1. A pneumatic vehicle tire in a radial construction comprising:
a radial carcass;
a profiled tread strip;
a belt; and,
a belt bandage covering the belt in one or more plies including strength members extending in the circumferential direction of the tire and including at least one yarn in a textile material,
wherein the yarn has a fineness ≦700 dtex.

2. The pneumatic vehicle tire as claimed in claim 1, wherein the yarn has a fineness ≦500 dtex.

3. The pneumatic vehicle tire as claimed in claim 1, wherein the strength members are twisted yarns.

4. The pneumatic vehicle tire as claimed in claim 1, wherein the strength members are tapes.

5. The pneumatic vehicle tire as claimed in claim 1, wherein the strength members are cords including two or more yarns in the same material.

6. The pneumatic vehicle tire as claimed in claim 5, wherein the cords have one of the constructions 1×1, 1×2 or 1×3.

7. The pneumatic vehicle tire as claimed in claim 6, wherein cords of the construction 1×1 have a twist factor α of 10 to 80, wherein
$$α = t / m \times \sqrt{\frac{dtex}{10000}} ,$$
where t/m is the number of twists per meter and dtex is the dtex of the entire cord.

8. The pneumatic vehicle tire as claimed in claim 6, wherein cords of the construction 1×2 or of the construction 1×3 have a twist factor α of 50 to 300, wherein
$$α = t / m \times \sqrt{\frac{dtex}{10000}} ,$$
where t/m is the number of twists per meter and dtex is the dtex of the entire cord.

9. The pneumatic vehicle tire as claimed in claim 1, wherein the strength members are spaced apart within and between bandage plies by a clear distance of not less than 0.1 mm.

10. The pneumatic vehicle tire as claimed in claim 1, wherein the yarn consists of a polyamide.

11. The pneumatic vehicle tire as claimed in claim 1, wherein the yarn is selected from the group consisting of polyester, rayon, and highly aromatic polyamide.

12. A method of manufacturing a bandage ply comprising:
twisting a yarn to form a twisted yarn having a fineness ≦700 dtex; and,
providing the twisted yarn as reinforcement cords for at least one bandage ply covering the belt of a pneumatic vehicle tire in radial construction.

13. The method as claimed in claim 12, wherein the yarn has a fineness ≦500 dtex.

14. The method as claimed in claim 12, wherein the yarn is selected from the group consisting of polyamide, polyester, and rayon.

15. The method as claimed in claim 12, wherein the yarn has a fineness of 700 dtex, 470 dtex, 312 dtex or 235 dtex.

16. The pneumatic vehicle tire as claimed in claim 7, wherein the twist factor α is of from 30 to 50.

17. The pneumatic vehicle tire as claimed in claim 8, wherein the twist factor α is of from 100 to 200.

18. The pneumatic vehicle tire as claimed in claim 10, wherein the polyamide is nylon-6,6.

19. The method as claimed in claim 14, wherein the yarn is nylon-6,6 or a highly aromatic polyamide.
